(19) United States
(12) Patent Application Publication
(10) Pub. No.: US 2014/0244167 A1
(43) Pub. Date: Aug. 28, 2014

(54) METHODS, APPARATUSES AND COMPUTER PROGRAM PRODUCTS FOR PROVIDING A LOCATION CORRECTION CACHE

(71) Applicant: NOKIA CORPORATION, Espoo (FI)

(72) Inventor: Franklin Darrel Reynolds, Lexington, MA (US)

(73) Assignee: NOKIA CORPORATION, Espoo (FI)

(21) Appl. No.: 13/781,372

(22) Filed: Feb. 28, 2013

(51) Int. Cl. G01C 21/00

(52) U.S. Cl. CPC G01C 21/00
USPC 701/518

(57) ABSTRACT

An apparatus for correcting one or more detected locations may include a processor and memory storing executable computer code causing the apparatus to at least perform operations including determining whether a detected location of a communication device was previously designated as an incorrect location. The computer program code may further cause the apparatus to enable provision of an option to a user of the communication device to select a specified correct location corresponding to the incorrect location in response to determining that the detected location was previously designated as the incorrect location. Corresponding methods and computer program products are also provided.

### TECHNOLOGICAL FIELD

An example embodiment of the invention relates generally to geolocation of communication devices and more particularly, relates to a method, apparatus, and computer program product for detecting locations of communication devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to geolocation services of communication devices. These geolocation services may be utilized to determine current locations of communication devices in the real-world. For a variety of reasons, it may be beneficial for a communication device to determine its current location. For example, applications of a communication device may request the current location of the communication device to enhance one or more services provided by the applications. Additionally, for example, the user of the communication device may desire to know the current location.

At present, communication devices may utilize various mechanisms for helping a user locate him or herself such as, for example, Global Positioning System (GPS), cell identification (cell-id), Wireless Fidelity (Wi-Fi) wireless access router (WAR) drive databases, etc. Many applications running on communication devices such as for example, mobile phones, laptop or desktop computers, etc. may attempt to use the best mechanism available to help users determine their location. Unfortunately, for various reasons, there are no perfect mechanisms for locating devices or users. There may be situations in which each technology utilized for detecting location of devices or users may fail.

For example, GPS may be unreliable in-doors and laptop applications, particularly web based applications, may rely on Internet Protocol (IP) addresses to determine location, which may also be unreliable. For instance, a location may be associated with an IP address utilized to connect to a network and the location may be designated as the location of a device. However, in some instances in which the device (e.g., laptop) connects to the network, a location (e.g., a neighboring town of a city) associated with the IP address may be different than the actual location (e.g., a city in which the user's home is located) of the device. Moreover, IP addresses may be misleading because of virtual private networks (VPNs) or network address translators (NATs) or other devices of network topology that make associating an IP address with a geolocation unreliable.

Additionally, Wireless Fidelity (Wi-Fi) access point neighborhood maps such as, for example, wireless access router (WAR) drive maps may be utilized to determine location of a device or user. However, usage of WAR drive maps to determine location is not particularly reliable.

Wardriving involves searching for Wi-Fi wireless networks by a person in a moving vehicle, using a portable computer, smartphone or personal digital assistant (PDA). Wardrivers may use a Wi-Fi equipped device to record the location of wireless networks. The results may be uploaded to a database where the data may be processed to form maps of a network neighborhood. The maps of known wireless networks may be used as a geolocation system to provide a location of a device connecting to a corresponding wireless network associated with the map(s). Although WAR drive databases may be useful, they are not always reliable.

For instance, Wi-Fi access point maps may be sparse and oftentimes the data may be stale (for example, because a Wi-Fi access point may move or change locations). A problem with relying on location results of WAR drive databases is that people driving around in the vehicles may not be able to detect wireless networks in a building. For example, the building may not be near a road or a street. In this regard, there may be deficiencies in the WAR drive database due, in part, to undetected wireless networks. As such, in an instance in which wireless networks may not be near the road because they are in a very tall building, or on a school campus or other location that is too far away from a public access road, the location of the wireless networks (e.g., wireless access points) may not be in a WAR drive database even though there may be a wireless network(s) in the building (e.g., a library, a church, a classroom on a college campus, a federal building, etc.)

As a result, in an instance in which a user is within the building (e.g., libraries, the classroom, etc.) and connects to a wireless network, the WAR drive database may provide the user with incorrect location data. For instance, the WAR drive database may not provide the correct location of the user and instead may provide data indicating the user is at another location corresponding to a location of another wireless network(s). Moreover, for example, each time a device of the user connects to the wireless network in the building, the WAR drive database may provide incorrect location data since the location of the wireless network in the building may not be detected and included in the WAR drive database. As such, the results of WAR drive maps are not always accurate for determining location.

In view of the foregoing drawbacks, it may be beneficial to provide an efficient and reliable mechanism of more accurately determining one or more locations of a communication device.

### BRIEF SUMMARY

A method, apparatus and computer program product are therefore provided for correcting one or more detected locations of a communication device. An example embodiment may provide a memory including a user location correction cache (also referred to herein as a correction cache). The correction cache may include data indicating locations (e.g., a list of locations) that a user corrected, for example, bad or incorrect locations and the sensor data or network context data that leads the system to the incorrect locations as well as the corresponding correct location(s) specified by the user. As such, the next time a communication device detects a location that matches a bad or incorrect location in the correction cache, the communication device may provide an alternate location that was specified or designated as a corresponding correct location.

In an instance in which a communication device of an example embodiment may determine a location of the communication device is incorrect, the communication device may correct the location based in part on receipt of data (e.g., input data from the user) indicating a correct location or some other determination of the correct location. For example, in an instance in which the communication device determines a particular location incorrectly and subsequently returns to the same location, the communication device may provide a location indicated by a user as being correct instead of the incorrect location determined by the communication device.

By utilizing an example embodiment, communication devices may provide users with a mechanism to make corrections in an instance in which a location detection service (e.g., based on GPS, cell identification, etc.) fails to provide the correct location.

In this regard, users revisiting locations (e.g., a workplace, school, home, homes of friends, favorite restaurants, favorite cafes, etc.) in which a communication device initially detected an incorrect location may utilize a correct location included a correction cache.

In one example embodiment, a method for correcting one or more detected locations is provided. The method may include determining whether a detected location of a communication device was previously designated as an incorrect location. The method may also include enabling provision of an option to a user of the communication device to select a specified correct location corresponding to the incorrect location in response to determining that the detected location was previously designated as the incorrect location.

In another example embodiment, an apparatus for correcting one or more detected locations is provided. The apparatus may include a processor and a memory including computer program code. The memory and computer program code are configured to, with the processor, cause the apparatus to at least perform operations including determining whether a detected location of the apparatus was previously designated as an incorrect location. The memory and computer program code are also configured to, with the processor, cause the apparatus to enable provision of an option to a user of the communication device to select a specified correct location corresponding to the incorrect location in response to determining that the detected location was previously designated as the incorrect location.

In another example embodiment, a computer program product for correcting one or more detected locations is provided. The computer program product includes at least one computer-readable storage medium having computer-readable program code portions stored therein. The computer-executable program code instructions may instructions may include program code instructions configured to determine whether a detected location of a communication device was previously designated as an incorrect location. The program code instructions may also enable provision of an option to a user of the communication device to select a specified correct location corresponding to the incorrect location in response to determining that the detected location was previously designated as the incorrect location.

An embodiment of the invention may provide a better user experience since communication devices may be able to efficiently and reliably mitigate or reduce failures in detecting locations of the communication devices. As a result, device users may enjoy improved capabilities with respect to location based services accessible via the device.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a schematic block diagram of a geopositioning system according to an example embodiment of the invention;

FIG. 5 is a diagram of a flowchart of an example method according to an example embodiment of the invention; and

FIG. 6 illustrates a flowchart for correcting one or more detected locations according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

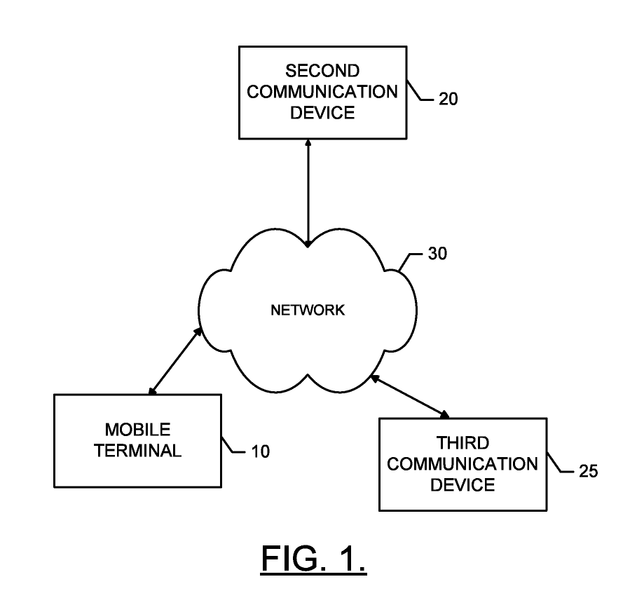

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

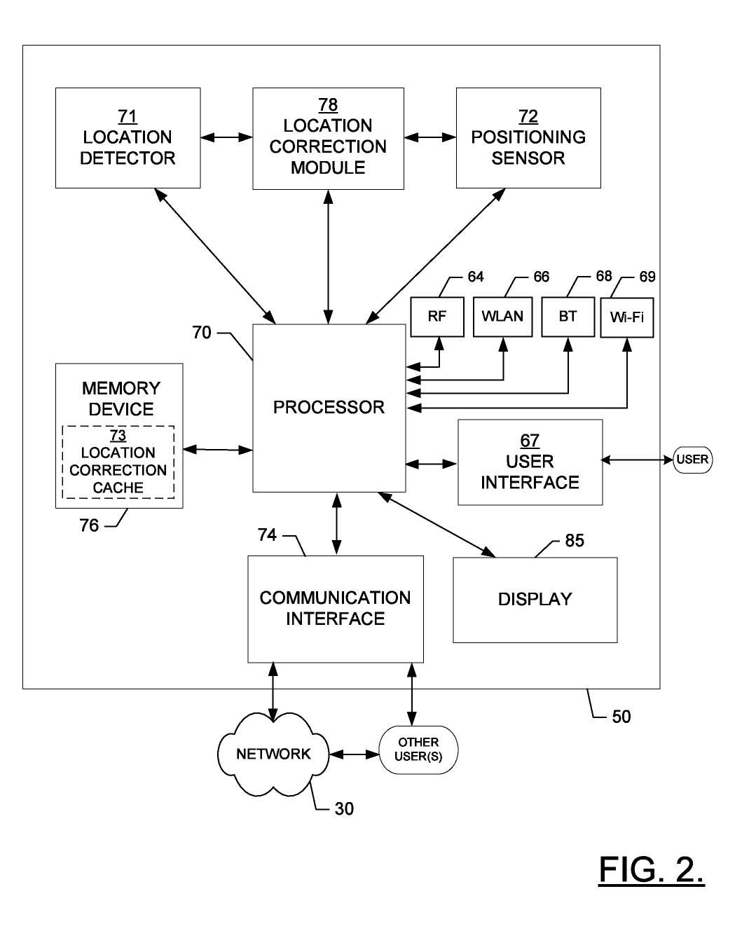

In an example embodiment, the mobile terminal as well as the second and third communication devices 20 and 25 may employ an apparatus (e.g., apparatus of FIG. 2) capable of employing an embodiment of the invention.

FIG. 2 illustrates a schematic block diagram of an apparatus for correcting one or more detected locations according to an example embodiment. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, a location correction module 78, a location detector 71 and a positioning sensor 72. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). The memory device 76 may also store data received from one or more radio frequency devices (e.g., access points (e.g., Wi-Fi access points, WLAN access points, RF access points, BT access points, IR access points, etc.) and/or cellular towers (e.g., base stations)). Additionally, the memory device 76 may include an optional location correction cache 73 (also referred to herein as user location correction cache 73). The location correction cache 73 may include data indicating one or more correct locations of apparatus 50.

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content, such as for example location-based content or any other suitable content, according to a Hypertext Transfer Protocol (HTTP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

As shown in FIG. 2, the apparatus 50 may also include one or more means for sharing and/or obtaining data. For example, the apparatus 50 may comprise a short range radio frequency (RF) transceiver and/or interrogator 64 so data may be shared with and/or obtained from electronic devices (e.g., a RF access point(s)) in accordance with RF techniques. The apparatus may comprise other short range transceivers, such as, for example, a WLAN transceiver 66, a Bluetooth™ (BT) transceiver 68 operating using Bluetooth™ brand wireless technology developed by the Bluetooth™ Special Interest Group, and/or the like. The Bluetooth transceiver 68 may be configured to operate according to Wibree™ radio standards. The apparatus 50 may also include a Wi-Fi transceiver 69 configured to transmit and/or receive data from electronic devices (e.g., a Wi-Fi access point(s)) according to a Wireless Fidelity (Wi-Fi) technique. In this regard, the apparatus 50 and, in particular, the short range transceiver may be capable of transmitting data to and/or receiving data from electronic devices (e.g., a WLAN access point(s), a BT access point(s), a Wi-Fi access point(s), a RF access point(s), etc.) within a proximity of the apparatus, such as within 10 meters, for example. The apparatus 50 may be configured to transmit and/or receive data from electronic devices according to various wireless networking techniques, including WLAN techniques such as IEEE 802.11 techniques, and/or the like.

In addition, the apparatus 50 may include a positioning sensor 72. The positioning sensor 72 may be any means such as a device or circuitry embodied in either hardware or a combination of hardware and software that is configured to determine the speed, velocity or acceleration of the apparatus 50 as well as a position(s) or location(s) of the apparatus 50. The positioning sensor 72 may determine the speed and acceleration in which the apparatus 50 is moving or traveling along a path or route, for example through timed location updates. For instance, the positioning sensor 72 is configured to determine the speed and acceleration in which the apparatus 50 is traveling based on changes in position at respective times. In this regard, the positioning sensor 72 is configured to determine the time that it takes the apparatus 50 to move from a first location to a second location in order to determine the speed in which the apparatus 50 is moving or travelling. In an example embodiment, the positioning sensor 72 may include a motion detection unit (e.g., an accelerometer, a gyrometer with associated algorithms) for obtaining the speed in which the apparatus 50 is traveling or moving.

Additionally, the positioning sensor 72 may include, for example, a global positioning system (GPS) sensor, an assisted global positioning system (Assisted-GPS) sensor, a Bluetooth (BT)-GPS mouse, other GPS or positioning receivers or the like. However, in one example embodiment, the positioning sensor 72 may include a pedometer or inertial sensor. In this regard, the positioning sensor 72 may be capable of determining a location of the apparatus 50, such as, for example, longitudinal and latitudinal directions of the apparatus 50, or a position relative to a reference point such as a destination or start point. The positioning sensor 72 may also be capable of determining an altitude of the apparatus 50 and use the altitude information in determining the location of the apparatus 50. Information from the positioning sensor 72 may then be communicated to a memory (e.g., memory device 76) of the apparatus 50 or to another memory device to be stored as a position history or location information. In this regard, for example, the position history may define a series of data points corresponding to positions or locations of the apparatus 50 at respective times. Various events or activities of the apparatus 50 may also be recorded in association with position history or location information provided by the positioning sensor 72.

In an example embodiment, the processor 70 may be embodied as, include or otherwise control the location detector. The location detector 71 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the location detector 71, as described below. Thus, in an example in which software is employed, a device or circuitry (e.g., the processor 70 in one example) executing the software forms the structure associated with such means.

The location detector 71 may facilitate detection of a location of the apparatus 50 based in part on received signals from one or more access points (e.g., Wi-Fi access points, WLAN access points), as described more fully below. In one example embodiment, the location detector 71 may, but need not, facilitate detection of a location of the apparatus 50 in an instance in which GPS may be unavailable or imprecise for determining a current location of the apparatus 50. For example, GPS may be, but need not be, unavailable or imprecise for determining the location of apparatus 50 in an instance in which the apparatus 50 is located indoors, located in an urban area or in any other instance in which signals from GPS satellites may be weak or may be difficult to receive by the positioning sensor 72.

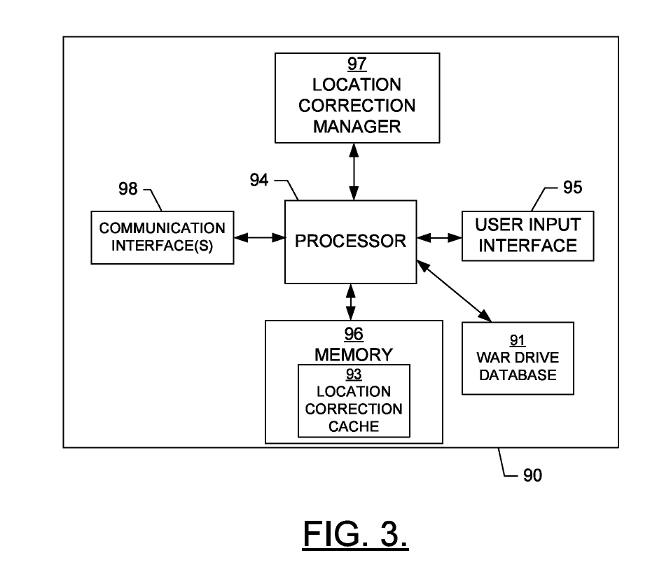

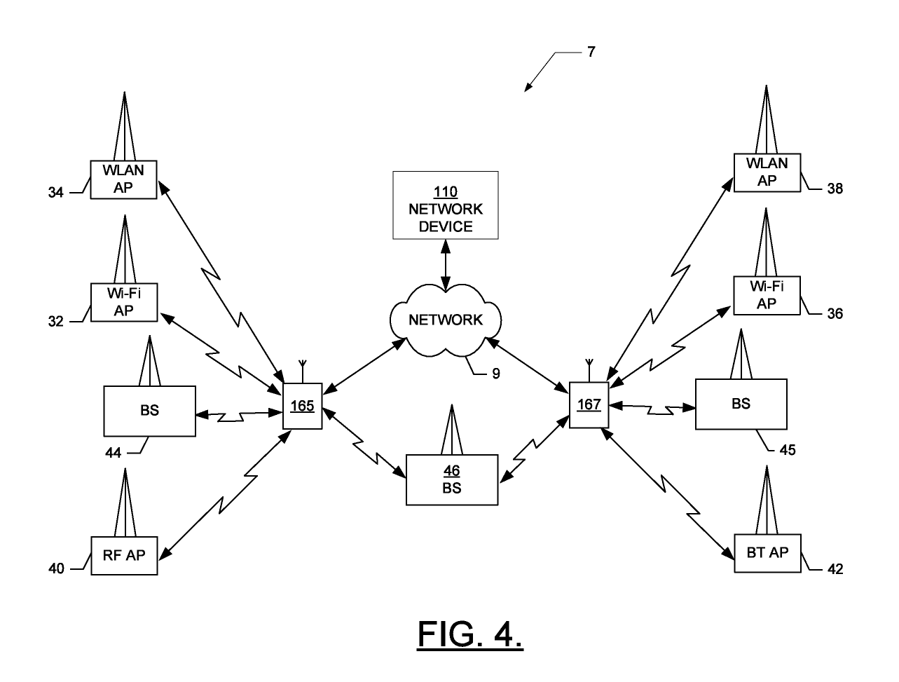

The location detector 71 may detect broadcast data (e.g., signals) received from one or access points (APs) including but not limited to one or more Wi-Fi access points, WLAN access points. In an example embodiment, the location detector 71 may receive detected signals from one or more WLAN access points (e.g., WLAN access point 34 of FIG. 4) and one or more Wi-Fi access points (e.g., Wi-Fi access point 32 of FIG. 4), via the WLAN transceiver 66 and the Wi-Fi transceiver 69, respectively. The location detector 71 may detect the signals received from one or more access points when the apparatus 50 is within a proximity or range of the access points. The detected signals from the access points may include, but is not limited to, data indicating the received signal strength of the signals detected from the access points, one or more network addresses, or other identifiers (e.g., network identifiers) identifying a corresponding access point(s), and any other suitable data. In one example embodiment, the location detector 71 may provide a network address(es) of a detected access point to a network device (e.g., network device 90 of FIG. 3) that includes a WAR drive database, and the network device may provide data indicating the location of the access point(s) to the location detector 71 based on the network address(es). In this regard, the location detector 71 may determine that a location of the apparatus 50 corresponds to a location of the access point(s) since the location detector 71 detected the access point(s).

In another example embodiment, the location detector 71 may estimate or determine the locations of the access points based in part on triangulating the current position from the signal strengths of detected network IDs associated with the access points.

As described above, the location detector 71 may also detect signals from one or more cellular towers (e.g., base stations 44, 45, 46 of FIG. 4). The location detector 71 may detect signals from the cellular towers in an instance in which the apparatus 50 is within a range of the cellular towers. The range may be the range within which the apparatus 50 may reliably connect to one or more of the cellular towers. The data of the signals received from one or more of the cellular towers may include, but is not limited to, the received signal strength of signals received from respective cellular towers, data identifying (e.g., a cell tower identifier (ID) (e.g., a base station ID)) a respective cellular tower, and any other suitable information. In an example embodiment, the location detector 71 may determine the location of the apparatus 50 based in part on the cell tower ID (also referred to herein as cell-id) of the apparatus 50.

In another example embodiment, the location detector 71 may determine a location of the apparatus 50 based in part on detecting one or more network addresses (e.g., IP addresses). For example, in response to connecting to a network (e.g., the Internet), the location detector 71 may identify a network address (e.g., an IP address, a Media Access Control (MAC) address) to connect with the network. The location detector 71 may determine a location (e.g., city, country, zip code, etc.) associated with the network address (e.g., IP address) and may determine that the location of the apparatus 50 corresponds to the location associated with the network address.

In an example embodiment, the processor 70 may be embodied as, include or otherwise control the location correction module 78. The location correction module may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the location correction module 78, as described below. Thus, in one example in which software is employed, a device or circuitry (e.g., the processor 70 in one example) executing the software forms the structure associated with such means.

The location detector 71 and/or the positioning sensor 72 may provide location information to the location correction module 78. In an instance in which the location detector 71 and/or the positioning sensor 72 (e.g., a GPS of the positioning sensor 72) determines a location of the apparatus 50 incorrectly, a user of the apparatus 50 may utilize the user interface 67 to specify the correct location (e.g., an address of the correct location) of the apparatus 50. In response to receipt of data indicating the correct location, the location correction module 78 may store the correct location data associated with the incorrect location in the location correction cache 73. As such, in an instance in which the location correction module 78 subsequently detects a location that the user designated as being incorrect, the location correction module 78 may provide an option to the user of the apparatus 50 to accept or select a corresponding location that the user previously specified as being correct as the location of the apparatus 50. The location correction module 78 may determine the location that the user specified as being correct based in part on analyzing data stored in the location correction cache 73 of the memory device 76.

For instance, in response to the location correction module 78 analyzing data received from a remote location correction cache (e.g., location correction cache 93 of FIG. 3) or the data stored in the location correction cache 73 and determining that the user specified a corresponding correct location for the incorrect location, the location correction module 78 may provide the user-specified correct location to the user as an option to select as the current location of the apparatus 50. The location correction module 78 may provide the user specified correct location to the user as an option for selection via a display (e.g., display 85).

For purposes of illustration and not of limitation, the GPS of the positioning sensor 72 may determine an incorrect location of apparatus 50 in an instance in which the apparatus 50 is located indoors, located in an urban area or in any other instance in which signals from GPS satellites may be weak or may be difficult to receive by the positioning sensor 72. Additionally, for purposes of illustration and not of limitation, the location detector 71 may determine an incorrect location of the apparatus 50 in an instance in which a location (e.g., a neighboring town) associated with a detected network address (e.g., an IP address), utilized to connect to a network (e.g., network 30), does not correspond to the actual location (e.g., a city in which the user resides) of the apparatus 50. Moreover, for example, the location detector 71 may determine an incorrect location of the apparatus 50 in response to receiving an indication of a location from a WAR driving database of a network device (e.g., network device 90 of FIG. 3) in which the indicated location is not the correct location of the apparatus 50.

Furthermore, for example, the location detector 71 may determine an incorrect location of the apparatus 50 based in part on a cell-id. For instance, a received signal strength of a cellular tower (e.g., a base station) serving the apparatus 50 may be too low to adequately determine the cell-id of the cellular tower. As such, the location detector 71 may be unable to correctly determine the location of the cellular tower based on the cell-id and as such may be unable to accurately determine the location of the apparatus 50.

In one example embodiment, the location correction module 78 may provide location correction data to a network device (e.g., network device 90 of FIG. 3) and the network device may utilize the location correction data, in part, to suggest or provide a correct current location of an apparatus (e.g., apparatus 50, other apparatuses 50) to a user. For example, in response to receiving an indication from the location correction module 78, or otherwise determining, that a detected location of the apparatus 50 is incorrect, the network device may provide a corresponding correct location to the apparatus 50.

Referring now to FIG. 3, a block diagram of one example of a network device is provided. In one example embodiment, the network device 90 may provide services (e.g., location services) to one or more devices (e.g., an apparatus 50, other apparatuses 50). As shown in FIG. 3, the network device (e.g., a server (e.g., communication device 20)) generally includes a processor 94 and an associated memory 96. The memory 96 may comprise volatile and/or non-volatile memory, and may store content, data and/or the like. For example, the memory may store content, data, information, and/or the like transmitted from, and/or received by, the network device. Also for example, the memory 96 may store client applications, instructions, and/or the like for the processor 94 to perform the various operations of the network device in accordance with an embodiment of the invention, as described herein. The memory 96 may include a location correction cache 93 (also referred to herein as user location correction cache 93). The data in the location correction cache 93 may include data specifying one or more corrected locations that correspond to determined incorrect locations. The corrected locations may be specified by one or more users of communication devices (e.g., apparatuses 50).

The network device 90 may also include a memory such as a WAR drive database 91 that includes locations of wireless access points (e.g., Wi-Fi APs, WLAN APs, BT APs, RF APs). In this regard, the WAR drive database 91 may store one or more maps of detected network identifiers (IDs) of the wireless APs which may be utilized for geolocation by determining a current location or position of a communication device(s) (e.g., apparatus 50) based in part on detecting received signal strengths (RSSs) of wireless access points corresponding to the detected network IDs.

In addition to the memory 96, the processor 94 may also be connected to at least one interface or other means for displaying, transmitting and/or receiving data, content, and/or the like. In this regard, the interface(s) may comprise at least one communication interface 98 or other means for transmitting and/or receiving data, content, and/or the like, as well as at least one user input interface 95. The user input interface 95, in turn, may comprise any of a number of devices allowing the network device to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In an example embodiment, the processor 94 may be embodied as, include or otherwise control the location correction manager 97. The location correction manager 97 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the location correction manager 97, as described below. Thus, in an example in which software is employed, a device or circuitry (e.g., the processor 94 in one example) executing the software forms the structure associated with such means.

The location correction manager 97 may receive data specifying correct locations from one or more apparatuses (e.g., apparatuses 50). The correct locations may correspond to one or more identified or determined incorrect locations. The correct locations may be specified by one or more users of the apparatuses. The location correction manager 97 may store the correct locations along with data indicating corresponding incorrect locations in the location correction cache 93.

In response to receipt of an indication of an incorrect location of an apparatus (e.g., apparatus 50), the location correction manager 97 may analyze data in the location correction cache 93 and detect a corresponding location designated as a correct location. The location correction manager 97 may provide the correct location to a location correction module (e.g., location correction module 78) of an apparatus which may provide the correct location as an option for a user of the apparatus (e.g., apparatus 50) to select as the location of the apparatus, as described more fully below.

Referring now to FIG. 4, an example embodiment of a system for correcting one or more locations is provided. The system 7 may include one or more access points (APs). The APs may include, for example, a Wi-Fi AP 32, WLAN AP 34, a Wi-Fi AP 36, a WLAN AP 38, a RF AP 40 and a BT AP 42. The system 7 (also referred to herein as geolocation system 7) may also include one or more cellular towers. The cellular towers may include, for example, base stations (BSs) 44, 45, 46. Additionally, the system 7 may include one or more communication devices 165 and 167 (e.g., apparatuses 50 (e.g., mobile terminal 10)) as well as a network device 110 (e.g., network device 90). In the example embodiment of FIG. 4, the network device 110 may provide location based services to the communication devices 165 and 167. The location based services may enable provision of one or more correct locations to one or more apparatuses (e.g., apparatuses 50) in response to detecting known corresponding incorrect locations.

Although FIG. 4 shows one Wi-Fi AP 32, one WLAN AP 34, one Wi-Fi AP 36, one WLAN AP 38, one RF AP 40, one BT AP 42, three cellular towers (e.g., BS's 44, 45, 46), two communication devices 165, 167, and a network device 110, it should be pointed out that any suitable number of Wi-Fi APs 32, WLAN APs 34, Wi-Fi APs 36, WLAN APs 38, RF APs 40, BT APs 42, cellular towers (e.g., BS's 44, 45, 46), communication devices 165, 167, and network devices 110 may be part of the system 7 without departing from the spirit and scope of the invention.

In the example of FIG. 4, the communication device 165 may detect signals (e.g., beacons) from one or more access points such as, for example, Wi-Fi AP 32, WLAN AP 34 and RF AP 40. Additionally, the communication device 165 may detect signals from one or more cellular towers (e.g., BS's 44 and 46). The communication device 167 may detect signals (e.g., beacons) from one or more access points such as, for example, Wi-Fi AP 36, WLAN AP 38 and BT AP 42. Furthermore, the communication device 167 may detect signals from one or more cellular towers (e.g., BS's 45 and 46).

In an example embodiment, a location detector (e.g., location detector 71) of the communication devices 165, 167 may detect the signals from the access points and/or the cellular towers. In this regard, the detected signals may include data associated, in part, with the received signal strengths of the respective signals received from the Wi-Fi AP 32, WLAN AP 34, Wi-Fi AP 36, WLAN AP 38, RF AP 40, BT AP 42 and the BS's 44 and 46 as well as content associated with the network addresses and/or identifiers of the Wi-Fi AP 32, WLAN AP 34, Wi-Fi AP 36, WLAN AP 38, RF AP 40, BT AP 42, base station IDs (e.g., cell-ids) corresponding to the BS's 44, 46 as well as other network identifiers (e.g., IP addresses, MAC addresses). In an example embodiment, a location detector (e.g., location detector 71) of the communication device 165 and/or a location detector (e.g., location detector 71) of the communication device 167 may utilize data of the detected signals to determine the location of the communication devices 165, 167. However, in some instances the determined location(s) may be incorrect.

For purposes of illustration and not of limitation, consider an instance in which a user utilizes communication device 165 to connect to a network (e.g., network 9). A network provider of the network may provide a network address (e.g., IP address, MAC address) for the connection to the network. The network address may be associated with a location (e.g., country, region, city, postal/zip code, latitude, longitude and time zone information). The location detector 71 may utilize the location associated with the network address as the location of the communication device. However, the location associated with the network address may correspond to a different location (e.g., a neighboring town) than the actual current location (e.g., a home of the user in a city in which the user of the communication device resides) of the communication device 165.

As such, a user may utilize an input device (e.g., user interface 67) to specify the correct location of the communication device 165. The location correction module (e.g., location correction module 78) of the communication device 165 may store this corrected location in a location correction cache (e.g., location correction cache 73) of the communication device 165 and may, but need not, also provide the corrected location to a location correction cache (e.g., location correction cache 93) of a network device (e.g., network device 110). In an instance in which the location detector of the communication device 165 detects the network address (e.g., an IP address), or another network address (e.g., another IP address) that is close to the network address, in a subsequent connection with the network, the location correction module may provide the corresponding correct location to the communication device. In this regard, the location correction module may provide the correct location previously specified by the user as an option for selection as the current location of the communication device.

In another example embodiment, the location correction manager (e.g., location correction manager 97) of the network device (e.g., network device 110) may provide the correct location specified by the user of the communication device 165 to another communication device (e.g., communication device 167). For instance, the location correction manager may provide the correct location to another communication device (e.g., communication device 167) in an instance in which the other communication device (e.g., communication device 167) utilizes the same network address, or a network address that is close to the network address, to connect to the network (e.g., network 9). In this manner, the user of the other communication device (e.g., communication device 167) may select the correct location instead of an incorrect location determined on the basis of the network address, or a network address that is close to the network address.

In another example embodiment, in an instance in which the location correction manager (e.g., location correction manager 97) of the network device determines that a predetermined number of users select the correct location in response to detecting the network address or a network address close to the network address, the location correction manager may provide the correct location to communication devices. For instance, the location correction manager may provide the correct location as the current location to corresponding communication devices of users and may not necessarily provide the incorrect location to the communication devices.

As another example, for purposes of illustration and not of limitation, consider an instance in which a location detector (e.g., location detector 71) of a communication device (e.g., communication device 167) detects one or more wireless access points (e.g., Wi-Fi AP 36, WLAN AP 38) in a vicinity of the communication device. The location detector may provide the network identifiers of the detected wireless access points to a network device (e.g., network device 110) and may request the network device to provide locations of the wireless access points.

However, the determined location may be incorrect. For instance, some of the detected wireless access points may have moved locations since their locations were previously captured and stored in the WAR drive database 91 and as such the locations of one or more of the wireless access points in the WAR drive database 91 may no longer be accurate. Additionally or alternatively, there may not be any locations for wireless access points in the WAR drive database 91 that are close enough to the communication device and as such the location detector 71 may be unable to accurately determine the location of the communication device (e.g., communication device 167).

As such, in this example, presume that the location correction module 78 of the communication device (e.g., communication device 167) determines that the location of the communication device is in Burlington, Massachusetts based on the locations associated with the network identifiers of the wireless access points provided by the location correction manager 97 of the network device 110. However, presume further that the communication device (e.g., communication device 167) is actually in an office building in Boston, Mass. In this regard, the user of the communication device (e.g., communication device 167) may utilize an input device (e.g., user interface 67) to specify the correct location (e.g., a correct address) of the communication device. The location correction module 78 of the communication device may store this correct location in a location correction cache (e.g., location correction cache 73) of the communication device. Additionally or alternatively, the location correction module 78 may, but need not, also provide the correct location to the location correction cache (e.g., location correction cache 93) of the network device (e.g., network device 110).

In this regard, in an instance in which the location detector 71 of the communication device (e.g., communication device 167) subsequently detects one or more of the network identifiers corresponding to one or more of the detected wireless access points, the location correction module 78 of the communication device, may provide the corresponding correct location to the user. For instance, the location correction module may provide the correct location to the user as an option for selection as the location of the communication device (e.g., communication device 167). The option may be provided to a display (e.g., display 85) of the communication device (e.g., communication device 167) for selection by the user.

In an example embodiment, in an instance in which a predetermined number of users select the correct location, the location correction manager 97 of the network device 110 may provide the correct location to communication devices of users and may not necessarily provide data corresponding to the locations of the network identifiers of the wireless access points since this may result in determining an incorrect location.

In one example embodiment, the location correction module 78 of a communication device (e.g., communication device 165, communication device 167) may apply one or more matching rules (also referred to herein as fuzzy matching rules) utilized by a location correction cache (e.g., location correction cache 93, location correction cache 73) in response to analyzing data to determine a match that corresponds to an incorrect location(s). A location that matches an incorrect location may be determined by the location detector 71 since latitude and longitude coordinates for a location may be slightly different for the same location that was considered an incorrect location. The matching rules are as follows.

A first matching rule may match a detected location(s) (e.g., geolocation(s)) as an incorrect location specified by a user or otherwise determined by the communication device (e.g., in response to the user specifying a correct location) in an instance in which the detected location is close to the incorrect location (e.g., close to the latitude and longitude coordinates of the incorrect location). In an example embodiment, a detected location may be close to an incorrect location in response to being within a predetermined distance (e.g., 50 meters) from the incorrect location. As such, locations detected by the location detector 71 as being close (e.g., within the predetermined distance) to an incorrect location may be designated as matching the incorrect location. In this regard, the location correction module 78 may provide the user with an option to select a designated correct location.

A second matching rule may be utilized in an instance in which geolocation information may be unavailable (or unreliable) to detect a location of a communication device. For example, when geolocation information is unavailable to detect the location of a communication device, the location detector 71 of the communication device may attempt to utilize network address (e.g., IP address) matching to detect location. Network addresses (e.g., IP addresses) may change because of a Dynamic Host Configuration Protocol (DHCP) or any other suitable reasons. However, network addresses (e.g., IP addresses, MAC addresses) may be allocated from a small, fixed range of addresses. As such, the location detector 71 may match a detected network address (e.g., IP address) with a network address determined to correspond to an incorrect location in an instance in which the detected network address is determined as being close to the network address corresponding to the incorrect location. In an example embodiment, a detected network address (e.g., IP address) may be determined as being close in an instance in which the detected network address is within the least significant 256 addresses of the network address corresponding to the incorrect location. For purposes of illustration and not of limitation, consider a network address (e.g., an IP address) of 10.200.168.1. In this example, a value of the least significant address is “1”. However, in an instance in which a detected network device has a least significant address(es) in the range of 0-255 (e.g., 256 addresses) (e.g., 10.200.168.250), the location correction module 78 may determine that the detected network is close to the network address corresponding to the incorrect location.

In an instance in which the detected network address is within the least significant 256 addresses, the location detector 71 may designate the detected network address as matching a network address of an incorrect location. As such, the location correction module 78 of the communication device may provide a specified correct location to the user as an option for selection as the location of a communication device.

Another matching rule may involve an x-forward via Hypertext Transfer Protocol (HTTP) header(s). The x-forward and via HTTP headers (in an instance in which they are available) may provide hints about network address translators (NATs), network proxies, virtual private networks (VPNs) and other middleware that may make it difficult to deduce a location of a communication device from a network address (e.g., IP address) alone. The x-forward HTTP header field may be utilized for identifying an originating network address (e.g., IP address) of a communication device connecting to a network device (e.g., network device 110 (e.g., a server)) through an HTTP proxy. These headers may be utilized by the location detector 71 to decide the manner in which to interpret a detected network address (e.g., IP address). For instance, the x-forward headers may be used to give a service (e.g., a location service) some indication of where a communication device is actually coming from or the route that was used to communicate with a network device (e.g., network device 110). If these headers match, then the location detector 71 may expand the range of network addresses (e.g., IP addresses) that match.

In this regard, by utilizing the x-forward, the location detector may analyze the devices that a communication device connected through such as, for example, VPNs, NATs, etc., that previously facilitated the connection to a network (e.g., network 9). In an instance in which the location detector 71 determines that a path in which the communication device connected to a network is similar to a previous path, the location detector 71 may determine that a network address (e.g., an IP address) corresponds or matches a location determined as an incorrect location. On the other hand, in an instance in which the subsequent path is different, for example, in an instance in which there are different devices in the path for connecting to the network, the location detector 71 may determine that there is no match and that the location associated with a detected network address (e.g., the IP address) is not the same location as the incorrect location.

Another matching rule may consider a time in which a correct location was created. In this regard, recent corrections may be determined by the location detector 71 as having a greater probability of being correct than older corrections. For example, in an instance in which the location correction cache 73 has more than one correction for a location, the location detector 71 may select the more recent correct location as opposed to the older correction.

This matching rule may also consider corrections to locations that recur in a regular pattern (e.g., during a work day, weekends, etc.). In this regard, the location detector 71 may determine that corrections to locations that recur in a regular pattern have a greater probability of being correct.

For purposes of illustration and not of limitation, during a time period (e.g., the morning) during the day (e.g., a work day) many users may utilize their communication devices as access points. By utilizing the communication devices as access points, the communication devices may be tethered or connected to another device and may serve as a hotspot for the other device (e.g., another communication device (e.g., a smart tablet)) to access or connect to a network (e.g., network 9). Since a communication device(s) may be mobile and may be utilized as a hotspot, the network identifier(s) and location(s) (e.g., an office of a company) of the communication device(s) may not necessarily be detected and stored in a WAR drive database (e.g., WAR drive database 91).

As described above, in one example embodiment, a location correction manager 97 may utilize a user's personal history of location corrections to improve the location service of the network device 110. For instance, in response to personal location correction histories being created for various users, the personal location corrections of the users may be aggregated and utilized to improve location services for multiple users. For example, the location correction manager 97 of the network device 110 may provide location corrections specified by a particular user to communication devices of multiple users. Even though location corrections of multiple users may be shared it should be pointed out that user anonymity is preserved and as such information that may be used to directly identify a user(s) may not be provided by the location correction manager 97.

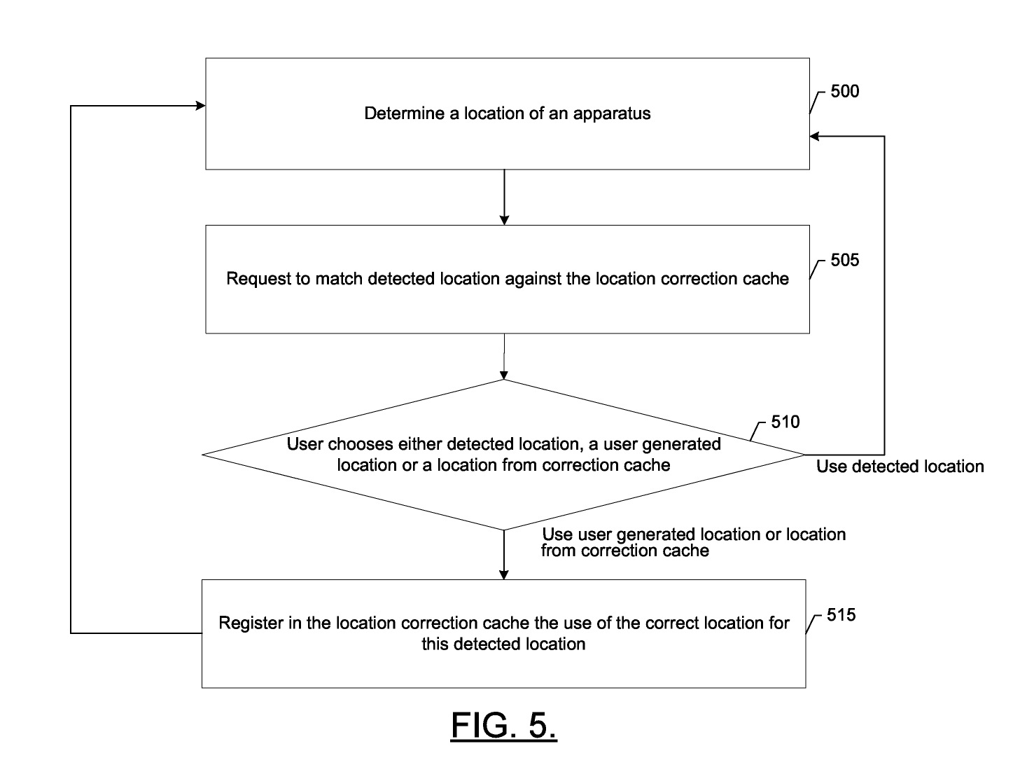

Referring now to FIG. 5, a flowchart for correcting a detected location is provided according to an example embodiment. At operation 500, an apparatus (e.g., apparatus 50 (e.g., communication device 165, communication device 167)) may determine a location of the apparatus. The apparatus may detect a location based in part on utilizing GPS, location data associated with a wireless access point in a WAR drive database (e.g., WAR drive database 91), a cell-id(s), a network address(es) (e.g., an IP address(es), a MAC address(es)) or any other suitable mechanisms. At operation 505, the apparatus (e.g., apparatus 50) may request to match the detected location against a corresponding location(s) in a location correction cache (e.g., location correction cache 73). In an example embodiment, the apparatus (e.g., apparatus 50) may apply one or more matching rules to determine whether a detected location matches an incorrect location. In an instance in which a location detector (e.g., location detector 71) of the apparatus (e.g., apparatus 50) determines that the detected location is close to the incorrect location, the location detector may determine that the detected location is also an incorrect location.

At operation 510, an apparatus (e.g., apparatus 50) may determine whether a user chooses the location detected by the apparatus, a user generated or specified location (e.g., a correct location currently specified by the user via user interface 67), or a location identified (e.g., a correct location previously specified by the user) in the location correction cache (e.g., location correction cache 73). In response to detecting that the user chose the location detected by the apparatus, the apparatus may determine another location of the apparatus when the apparatus is moved to another location. At operation 515, an apparatus (e.g., apparatus 50) may register in the location correction cache the use of a correct location for this detected location in response to receiving an indication of input of the user generated location or an indication of a selection of a corresponding correct location identified in the location correction cache (e.g. location correction cache 73). By registering the use of the correct location in the location correction cache, a location correction module (e.g., location correction module 78) of the apparatus (e.g., apparatus 50) may provide the correct location (e.g., via display 85) to the user for selection in response to detecting that the correct location is registered a predetermined number of times. In response to detecting user input a generated/specified location or that the user chose a location correction stored in a location correction cache (e.g., location correction cache 73), the apparatus may determine another location of the apparatus when the apparatus is moved to another location.

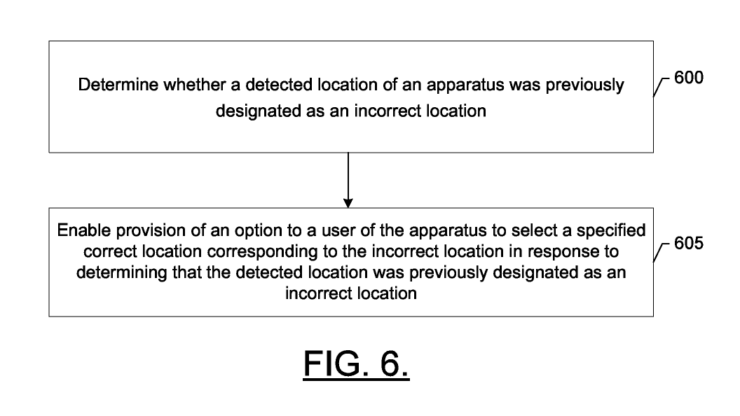

Referring now to FIG. 6, a flowchart of an example method for correcting one or more detected locations is provided. At operation 600, an apparatus (e.g., apparatus 50 (e.g., communication device 165, communication device 167)) may determine whether a detected location of the apparatus was previously designated as an incorrect location (for example by analyzing data in a location correction cache 73 specifying that the detected location is incorrect). At operation 605, an apparatus (e.g., apparatus 50) may enable provision of an option (e.g., via a display (e.g., display 85)) to a user of the apparatus to select a specified correct location corresponding to the incorrect location in response to determining that the detected location was previously designated as an incorrect location (e.g., previously designated by the user as being an incorrect location).

It should be pointed out that FIGS. 5 and 6 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94, location correction module 78, location detector 71, positioning sensor 72 and location correction manager 97). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 5 and 6 above may comprise a processor (e.g., the processor 70, the processor 94, the location correction module 78, the location detector 71, the positioning sensor 72, the location correction manager 97) configured to perform some or each of the operations (500-515, 600-605) described above. The processor may, for example, be configured to perform the operations (500-515, 600-605) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (500-515, 600-605) may comprise, for example, the processor 70 (e.g., as means for performing any of the operations described above), the processor 94, the location correction module 78, the location detector 71, the positioning sensor 72, the location correction manager 97 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining whether a detected location of a communication device was previously designated as an incorrect location;
enabling provision of an option to a user of the communication device to select a specified correct location corresponding to the incorrect location in response to determining that the detected location was previously designated as the incorrect location; and
enabling provision of the specified correct location, via the communication device, to the user in response to a subsequent detection by the communication device of the incorrect location in an instance in which the detected location is subsequently detected by the communication device.

2. The method of claim 1, further comprising:
selecting the specified correct location from a non-transitory memory storing a plurality of correct locations corresponding to previously detected incorrect locations of the communication device.

3. The method of claim 1, further comprising:
determining that the detected location corresponds to the incorrect location in response to determining that the detected location is close to the incorrect location.

4. The method of claim 3, wherein determining that the detected location is close to the incorrect location comprises detecting that the detected location is within a predetermined distance of the incorrect location.

5. The method of claim 3, wherein determining that the detected location is close to the incorrect location comprises detecting that a network address associated with the detected location comprises a least significant value within a predetermined range of addresses in an instance in which a least significant value of another network address associated with the incorrect location is within the predetermined range of addresses.

6. The method of claim 1, further comprising:
analyzing an x-forward via Hypertext Transfer Protocol header to determine that the detected location corresponds to the incorrect location.

7. The method of claim 2, further comprising:
registering an indication in the memory of a selection of the specified correct location as a current location of the communication device.

8. The method of claim 1, wherein:
enabling provision further comprises enabling provision of the specified correct location to the user of the communication device as the current location of the communication device in response to a detection that the specified correct location was previously selected a predetermined number of times.

9. The method of claim 1, wherein the incorrect location is based in part on detecting at least one location of at least one detected access point in which the at least one location does not correspond to the correct location.

10. The method of claim 1, wherein the incorrect location is based in part on detecting at least one location associated with a network address in which the at least one location does not correspond to the correct location.

11. The method of claim 1, further comprising:
enabling provision of another option to the user to select a different correct location, specified by another user, as a correct current location of the communication device in response to detecting another incorrect location of the communication device.

12. An apparatus comprising:
at least one processor; and
at least one non-transitory memory including computer program code configured to, with the at least one processor, cause the apparatus to perform at least the following:
determine whether a detected location of the apparatus was previously designated as an incorrect location;
enable provision of an option to a user of the apparatus to select a specified correct location corresponding to the incorrect location in response to determining that the detected location was previously designated as the incorrect location; and
enable provision of the specified correct location, via the apparatus, to the user in response to a subsequent detection by the apparatus of the incorrect location in an instance in which the detected location is subsequently detected by the apparatus.

13. The apparatus of claim 12, wherein the memory and computer program code are configured to, with the processor, cause the apparatus to:
select the specified correct location from the memory storing a plurality of correct locations corresponding to previously detected incorrect locations of the apparatus.

14. The apparatus of claim 12, wherein the memory and computer program code are configured to, with the processor, cause the apparatus to:
determine that the detected location corresponds to the incorrect location in response to determining that the detected location is close to the incorrect location.

15. The apparatus of claim 14, wherein the memory and computer program code are configured to, with the processor, cause the apparatus to:
determine that the detected location is close to the incorrect location by detecting that the detected location is within a predetermined distance of the incorrect location.

16. The apparatus of claim 14, wherein the memory and computer program code are configured to, with the processor, cause the apparatus to:
determine that the detected location is close to the incorrect location by detecting that a network address associated with the detected location comprises a least significant value within a predetermined range of addresses in an instance in which a least significant value of another network address associated with the incorrect location is within the predetermined range of addresses.

17. The apparatus of claim 12, wherein the memory and computer program code are configured to, with the processor, cause the apparatus to:
analyze an x-forward via Hypertext Transfer Protocol header to determine that the detected location corresponds to the incorrect location.

18. The apparatus of claim 13, wherein the memory and computer program code are configured to, with the processor, cause the apparatus to:
register an indication in the memory of a selection of the specified correct location as a current location of the apparatus.

19. The apparatus of claim 12, wherein the memory and computer program code are configured to, with the processor, cause the apparatus to:
enable provision by enabling provision of the specified correct location to the user of the apparatus as the current location of the apparatus in response to a detection that the specified correct location was previously selected a predetermined number of times.

20. The apparatus of claim 12, wherein the incorrect location is based in part on detecting at least one location of at least one detected access point in which the at least one location does not correspond to the correct location.

21. The apparatus of claim 12, wherein the incorrect location is based in part on detecting at least one location associated with a network address in which the at least one location does not correspond to the correct location.

22. The apparatus of claim 12, wherein the memory and computer program code are configured to, with the processor, cause the apparatus to:
enable provision of another option to the user to select a different correct location, specified by another user, as a correct current location of the apparatus in response to detecting another incorrect location of the apparatus.

23. A computer program product comprising at least one non-transitory computer-readable storage medium having computer-readable program code portions stored therein, the computer-readable program code portions comprising:
program code instructions configured to determine whether a detected location of a communication device was previously designated as an incorrect location;
program code instructions configured to enable provision of an option to a user of the communication device to select a specified correct location corresponding to the incorrect location in response to determining that the detected location was previously designated as the incorrect location; and
program code instructions configured to enable provision of the specified correct location, via the communication device, to the user in response to a subsequent detection by the communication device of the incorrect location in an instance in which the detected location is subsequently detected by the communication device.

24. The computer program product of claim 23, further comprising:
program code instructions configured to select the specified correct location from a non-transitory memory storing a plurality of correct locations corresponding to previously detected incorrect locations of the communication device.
